(19) United States
(12) Patent Application Publication
(10) Pub. No.: US 2005/0000568 A1
(43) Pub. Date: Jan. 6, 2005

(54) Rapid access coupling system for pneumatic tires

(76) Inventors: Ilya Nikolayev, Briarwood, NY (US); Nikolay Nikolayev, Briarwood, NY (US)

Correspondence Address: ILYA NIKOLAYEV, 139 - 27 PERSHING CRESCENT, BRIARWOOD, NY, 11435, US

(21) Appl. No.: 10/834,766

(22) Filed: Apr. 28, 2004

Related U.S. Application Data
(63) Continuation-in-part of application No. 10/634,932, filed on Aug. 5, 2003.
(60) Provisional application No. 60/466,328, filed on Apr. 29, 2003.

(51) Int. Cl. F16K 15/20

(52) U.S. Cl. 137/231

(57) ABSTRACT

A kit and method of converting a conventional automotive tire or the like into a rapid access coupling system to provide a means of quickly connecting or disconnecting a pressurized air or fluid source to the tire in order to inflate or deflate the tire or deliver a fluid therein or evacuate it there from. The kit includes the adaptor configured to be sealingly attachable to the tire valve stem and a source of pressurized fluid such as pressurized air, a gas mixture or another fluid, having a hose with the rapid connect coupler disposed at one end and another end connected to the outlet port of the supply. The rapid connect coupler assembly is equipped with a centrally located core depressor for engaging with a tire valve core and for moving it into the open position when the rapid connect coupler is attached onto the adapter. The sealing member installed inside the adapter is used to prevent fluid leakage during the pressurizing of the system and to provide a reliable seal between the adaptor and the rapid connect coupler prior to the opening or closing of the tire valve thus securely isolating the contents of the tire from the environment. The rapid connect coupler has a plurality of bearings serving as detaining elements for permanent, fast and reliable lockage of the coupler onto the adapter. The adaptor is configured to accept the displaceable bearings and to allow the bearings to fall behind the flange formed on the outer periphery of the adapter thus being locked between the outer surface of the adapter and inner surface of the coaxially movable collar. Pulling the collar coaxially and away from the adapter releases the bearings from their locked deployment and allows the valve member to return to its upright closed position.

### BACKGROUND OF THE INVENTION

1. Field of the Invention

The invention relates to the field of pneumatic tire inflating apparatuses and more specifically to a coupling system for inflating or deflating automotive tires and the like in maintenance and repair situations.

2. Description of the Related Art

A majority of motor driven vehicles including automobiles, trucks, off-road vehicles, sport utility vehicles, all-terrain vehicles, motorcycles and the like ride on pneumatic tires made of a flexible, elastic, rubber-like material, which is sealingly mounted on a rigid rim. An air or gas mixture contained in the toroidal cavity formed between a tire and a rim is what provides the tire with its smooth ride on a highway or any other level road, its toughness through a desert or mud, and its ability to carry a weight load.

An essential and, by all means, the most critical element of any tire design is a tire stem with a valve core installed in it. The stem and the valve provide access into an otherwise sealed internal tire cavity and at the same time act to keep the air in the tire. Similarly, they serve as the only means of conveying air or other substances into the tire.

Thus, it is extremely important to have ready access to the stem valve during maintenance and repair purposes, including tire inflation or deflation, and when a gas mixture or other substance must be delivered into or evacuated from a tire.

The majority of tire stems are equipped with a tapped inlet nipple. Thus, there is a group of couplers that must be screwed onto a tire stem to form a passage for the air to be conveyed from the air source into a tire. An example of this kind of coupler is disclosed in U.S. Pat. No. 5,305,784. Because of the fine pitch of the stem thread and the mainly rigid connection between the coupler and the hose it is not an easy task to find the beginning of the thread. In addition, after every revolution, the hose becomes twisted and the user is forced to straighten it out in order to be able to proceed with the next revolution. Also, because the process of unscrewing the coupler off the stem is slow and the air passage thus becomes open before the valve stem returns to its closed position, there will always be a substantial amount of air lost after inflation thus making this method imprecise and unfriendly.

U.S. Pat. No. 3,926,205 teaches a tire chuck having a long gasket and a lever mechanism which, when moved, compresses the gasket and subsequently opens the tire stem valve. Although the device provides a fast means of making a coupling with a tire stem, it attempts to seal around a threaded surface, which was never proven to be a successful task. Another problematic outcome of this design is that the compression of the gasket necessary to properly seal is about 3 millimeters and the user must overcome the resistance of a 3-millimeter thick layer of rubber and the stiffness of the tire valve spring. Although these types of tire chucks are widely used on various types of tire inflating devices, they were found to be faulty in both the reliable opening of the stem valve and the providing of good sealing properties between the gasket and the surface of the stem thread. Poor control over the proper alignment of the chuck, which must be in place to open the stem valve, adds to the scope of the problems. The user must also perform two actions simultaneously—he must depress the lever while making sure to push the chuck in a direction that opposes the resistance placed on it by the tire stem. Only until the compression of the gasket is sufficient to expand it radially inward thus providing grip between itself and the threaded surface of the tire stem can the user finally lock the chuck into place.

U.S. Pat. No. 4,276,898 discloses a clip-on type of air chuck which is supposed to seal on the face surface of the stem and at the same time open the stem valve. This chuck uses a lever type spring-loaded mechanism to lock itself in its operable position using the portion of the lever clenched between the two co-residing threads. These types of chucks use the fine pitched thread of the stem and thus cannot provide enough holding force for forming a reliable passage for the air passing from the air compressor to the tire.

In all of the referenced materials, despite the obvious differences of the devices disclosed, all of them have common and known problems. None of them offer reliable sealing between a chuck and a tire stem. Most do not offer a means of providing proper alignment between a tire stem and a chuck. Also they do not offer a reliable mechanism to open and release the stem valve without the loss of a substantial amount of fluid from the tire thus providing no control over sustaining an accurate pressure level inside the tire after inflation, which is extremely important for the safe operation of a vehicle. In addition, there is no locking mechanism provided which can be utilized to gain fast access into the inside cavity of the tire.

There is a long-waited need in the field of art for the coupling system to give rapid access to the pressurized air or other gas or fluid substance in the tire so that anyone, from an ordinary motorist to a heroic soldier on the battlefield, can maintain the tire as needed—efficiently without suffering from the above mentioned drawbacks.

### SUMMARY OF THE INVENTION

Accordingly, it is an object of the invention to provide an average motorist with a rapid tire access system allowing quick and hassle free connecting or disconnecting of the source of the pressurized substance to be delivered into the tire for maintenance or repair purposes.

It is another object of the invention to provide a dependable operating system which when used will always form an uninterrupted passage for the substance to flow into the tire or for the substance to be withdrawn from the tire.

It is another object of the invention to provide a simple and user-friendly functioning system through which connecting or disconnecting can be performed even by an unskilled operator.

It is another object of the invention to provide a reliable system, which can withstand high-pressure levels (up to 300 PSI) without abruptly disconnecting from the tire stem or the breaking apart of itself.

It is another object of the invention to provide an easily implementable system through which there is little force needed for the rapid coupler to be connected or disconnected.

It is another object of the invention to provide a leak-free connection between the substance source and the tire valve.

The above and other objects are fulfilled by the invention, which is a rapid tire stem access system and includes an adapter, a rapidly acting coupler, and a hand tool.

### BRIEF DESCRIPTION OF THE DRAWINGS

FIG. 1 shows a longitudinal section of a tire stem, with a preferred adapter installed, and rapid coupler coaxially aligned but separated. A stop valve is in the closed position.

FIG. 2 shows a longitudinal section of a tire stem, adapter, and rapid coupler coaxially aligned and in the position occurring immediately before either lockage or separation, with the collar in the retracted position, the balls separated and the stop valve closed.

FIG. 3 shows a longitudinal section of a tire stem, adapter, and rapid coupler coaxially aligned and locked, with the stop valve in its open position.

FIG. 4 shows a longitudinal section of a typical pneumatic tire stem and adapter in accordance with the invention. The stop valve is closed.

FIG. 5 is a section view of the tire stem and adapter according to claim 17 of the present invention

FIG. 6 shows a longitudinal section and represents another possible variant of a quick coupler.

FIG. 7 shows a longitudinal section and represents another possible variant of a quick coupler with a pressure stop valve in it.

### DETAILED DESCRIPTION OF THE PREFERRED EMBODIMENTS AND DRAWINGS

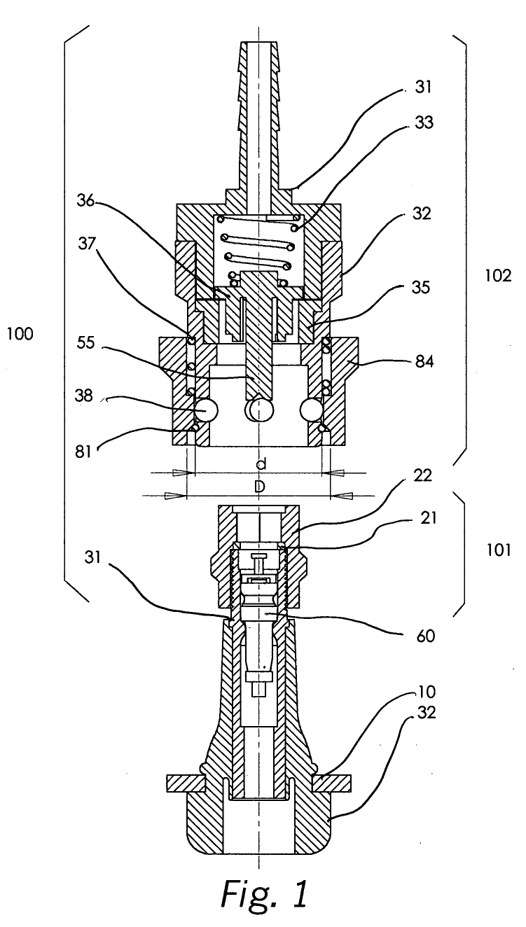

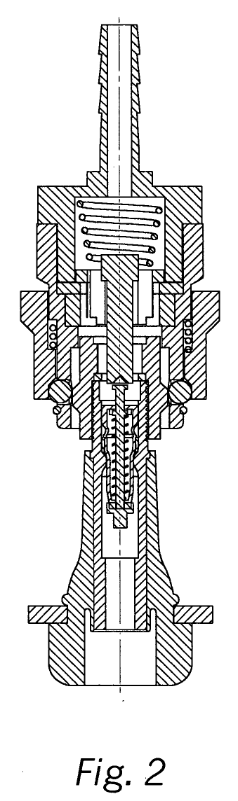

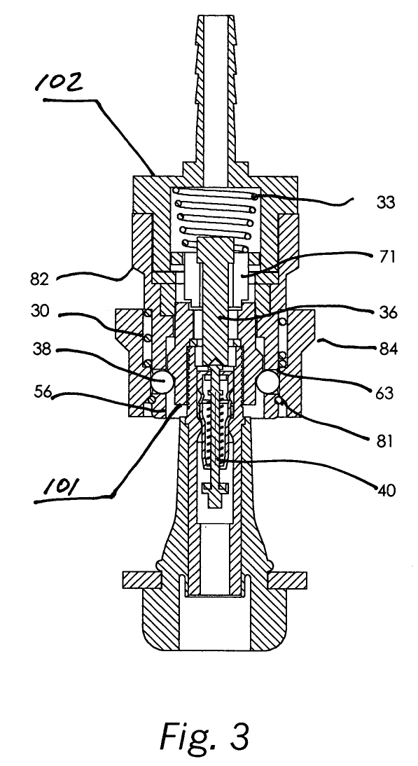

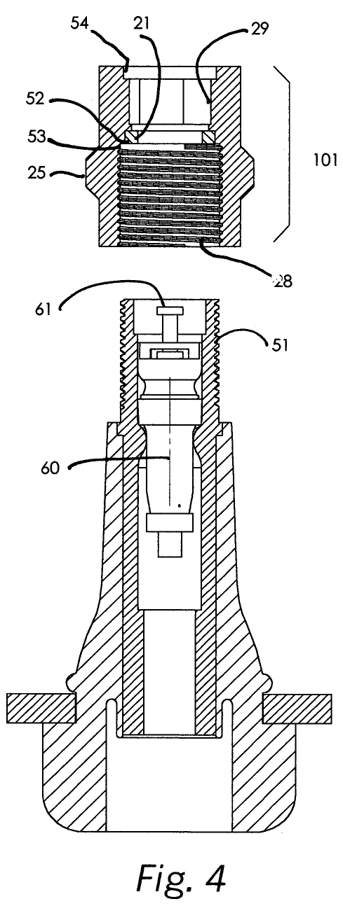

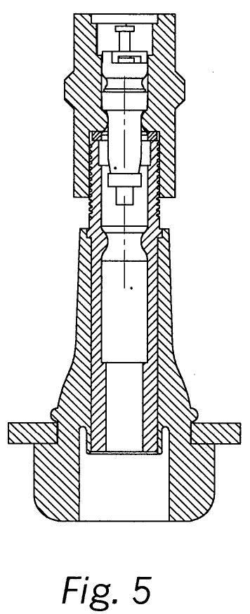

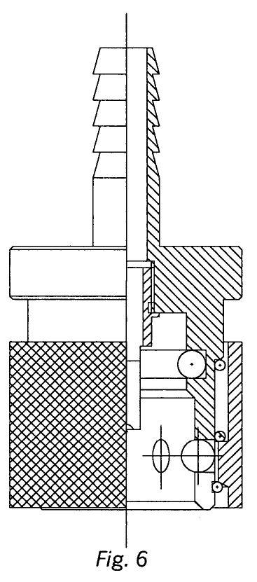

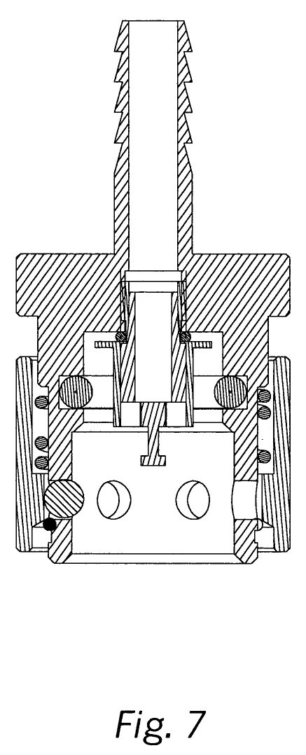

Referring now in detail to the drawings and initially to FIG. 1, a preferred embodiment of the present invention is illustrated by way of showing a coupling system indicated at 100. The coupling system comprises an adapter 101, and a coupler 102. The adapter 101, is permanently attached to the nipple 51 of FIG. 4, of the tire stem by means of the internal thread 28. The previously mentioned thread of the adapter is substantially the same thread as that of the nipple of the tire stem. In other words, the thread of the adapter and the thread of the nipple of the tire stem have a substantially similar pitch and diameter. A key way 29, accepts the provided hand tool (not shown) which is to be used for installation. The sealing element 21, is installed inside the annular groove 52, to preclude leakage of the pressurized fluid during operation. The location of the shoulder 53, provides the correct positioning of the release pin 61 of the stem valve 60 in relation to the couplers depression pin. The depression pin and the coupler are kept within the distance from the minimum pin location, at the breach of the seal, to the maximum coupling depression location. The internal recess 54 shown in FIG. 4 is used to accept the corresponding portion 55 in FIG. 1, of the depression pin thus preventing the stop valve from being damaged due to travel beyond the maximum coupling depression location. Channels 71 in FIG. 3 are cut through the depression pin body to provide unrestricted passage for the fluid disregarding the otherwise potentially disruptive displacement of the depression pin during operation. The socket 30, of the coupler 102, is configured to receive the adapter 101 as shown in FIG. 3. The socket wall 56 has a circumferential row of spaced-apart orifices 63 in which the detents 38 are held. The orifices are shaped as to restrict the radial inward location of the detents. More specifically, this location is restricted to be substantially equal to the diameter of the nose and rear portions of the adapter 101. In the illustrated preferred embodiment, the detents 38, are in the form of spherically-shaped locking elements, which are adapted to releasably engage between the internal surfaces of the collar 84, and the flange 25. The collar 84, which is mounted around the socket body 32, for axial movement, restricts the outward radial displacement of the detents to be equal to one and a half of the difference between the diameters of the cylindrical surface of the collar at D and d. The collar 84, is normally biased forward to its locking position by the spring 37, which is held between the internal shoulder of the locking sleeve and the external shoulder of the socket body. The forward movement of the locking sleeve is limited by the retaining ring 81, while the rearward movement is limited by the shoulder 82, of the socket body. With the adapter 101, and coupler 102, coaxially aligned and locked as shown in FIG. 3, a passage for a pressurized medium is formed. The depression pin 36, which is normally biased forward by the spring 33, opens a stop valve 40, and thereafter engages with relief 54 inside the front end of the adapter. When the collar is in a retracted position, as is shown in FIG. 2, the detents are free to move radially outward and to unlock from behind the flange 33. The spring depression acting against relief 54, of the adapter provides an additional force to help the process of disengagement. The present graphic representation of the invention is exemplary and is by no means intended to limit the implementations of the invention to the one described. Therefore FIG. 6 and FIG. 7 show other possible solution utilizing other designs of the coupling devices. FIG. 6 shows a coupler equipped with a fixed depression embodiment while FIG. 7 shows a coupler equipped with its own stop valve. FIG. 5 shows another embodiment, which comprises the described adapter with a stop valve incorporated in it. Without further analysis and without going beyond and outside the scope of the present claims, it is understandable that others can, by applying current knowledge, adapt the concepts of these claims. Nonetheless, they will not depart from the meaning and range of the present claims.

1. A kit for converting a conventional automotive tire stem into a rapid coupling system, said kit comprising:
a hollow open end adapter having a coupling flanged exterior portion and internal threads for sealing and obdurate attachment onto a conventional tire stem, which belongs to a tire mounted on a rim;
a generally hollow rapidly actuatable coupler that is releasably engageble with said adapter for an interlocking relation between said adapter and said coupler through at least one displaceable detent, said coupler having second end for connecting to hose from fluid supply thus providing a through passage for convening a fluid to the tire or from it;
a hand tool for said adapter installation;
a protective cap for protecting said adapter from obstacles.

2. An adapter of claim 1 wherein said adapter includes a sealing element mounted in a circumferential groove to prevent leakage between said adapter and the tire stem.

3. An adapter of claim 1 wherein said adapter has a key way with at least one flat surface to accept said hand tool.

4. An adapter of claim 1 wherein said adapter is installed on the tire stem in a proximity, which allows the reliable opening of the stem valve.

5. An adapter of claim 1 wherein said adapter has a flange around which the detents lock.

6. An adapter of claim 1 wherein internal threads of said adapter are covered with a thread sealing adhesive.

7. A hand tool of claim 1 wherein said hand tool can be easily inserted into the key-way of the adapter of claim 1 for installation.

8. A coupler of claim 1 wherein said coupler has at least one displaceable detent.

9. An adapter of claim 1 wherein said detents are lockable between the sleeve and the collar of the coupler.

10. An adapter of claim 1 wherein said detents form a releasable joint between the adapter and the coupler upon release of the collar of the coupler.

11. A coupler of claim 1, wherein said coupler has a spring for locking and unlocking the coupler onto or from the adapter.

12. A coupler of claim 1, wherein said coupler has a centrally positioned core depressor for opening the tire valve stem.

13. A coupler of claim 1, wherein said coupler has a sealing element to prevent leakage.

14. A coupler of claim 1, wherein said coupler has an open outlet for attaching it to the source of pressurized fluid.

15. A coupler of claim 1, wherein said coupler provides access into the otherwise sealed tire.

16. A coupler of claim 1, wherein said coupler provides access into the tire thru the tire stem valve.

17. An adapter of claim 1 wherein said adapter is fitted with a pressure stop valve.

18. An adapter of claim 1 wherein said adapter forms a 90 degree angle between a flange portion and a threaded portion.

19. An adapter of claim 1 wherein said adapter forms 180 degree angle between a flange portion and a threaded portion.

20. An adapter of claim 1 wherein said adapter has a U-shape.
